(19) United States
(12) Patent Application Publication
(10) Pub. No.: US 2026/0079981 A1
(43) Pub. Date: Mar. 19, 2026

(54) TECHNIQUES FOR GENERATIVE ARTIFICIAL INTELLIGENCE OUTPUT VERIFICATION

(71) Applicant: Verax AI Trust LTD, Ramat Gan (IL)

(72) Inventors: Leonid FEINBERG, London (GB); Oren GEV, Plano, TX (US); Roi PANAI, Or Yehuda (IL)

(73) Assignee: Verax AI Trust LTD, Ramat Gan (IL)

(21) Appl. No.: 18/889,059

(22) Filed: Sep. 18, 2024

(51) Int. Cl. G06F 16/33; G06N 5/02

(52) U.S. Cl. CPC G06F 16/3347; G06N 5/02

(57) ABSTRACT

A system and method for improving generative artificial intelligence (AI) software application response is provided. The method includes: receiving a query directed to a generative AI software application; receiving a response to the query, the response generated by the generative AI software application; generating a first contextual value based on the received query; generating a second contextual value based on the received response; generating a verification score based on the first contextual value and the second contextual value; and initiating a mitigation action in response to detecting that the verification score is below a predetermined threshold

### TECHNICAL FIELD

The present disclosure relates generally to generative artificial intelligence, and specifically to verifying outputs of generative AI.

### BACKGROUND

Generative artificial intelligence (AI) refers to systems that can create new content, such as text, images, or music, based on patterns and data they have been trained on. These models, such as GPT, BERT, LLaMa, GANs, and the like, learn from vast datasets to produce outputs that mimic human creativity and can be indistinguishable from human-generated content.

In an enterprise setting, generative AI can be employed in various ways. For instance, in marketing, it can generate personalized content for email campaigns or social media posts, tailoring messages to different customer segments. In product design, generative AI can create innovative designs or prototypes, accelerating the development process and enabling rapid iterations. Additionally, it can assist in customer service by generating natural language responses in chatbots, providing more human-like interactions with customers.

Despite its advantages, generative AI faces several challenges. One major problem is the potential for generating biased or inappropriate content, as these models can inadvertently learn and propagate biases present in the training data. This can lead to ethical concerns and reputational risks for enterprises.

Another issue is the difficulty in controlling and predicting the outputs of generative models, which can produce unexpected or undesired results. This unpredictability poses challenges in quality control and consistency, particularly in contexts where precision is critical.

Additionally, AI hallucinations occur when an AI system generates outputs that are incorrect or nonsensical, despite appearing plausible. This happens because generative AI models, such as large language models, predict responses based on learned patterns from vast datasets, rather than understanding the content in a human-like way. For example, an AI might confidently state a fabricated historical fact or create a fictitious citation.

These hallucinations are problematic, particularly in contexts requiring accuracy and reliability, such as medical, legal, or academic fields. Users might unknowingly trust the incorrect information, leading to misinformation and potential harm. Additionally, frequent hallucinations can erode trust in AI systems.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include receiving a query directed to a generative AI software application. The method may also include receiving a response to the query, the response generated by the generative AI software application. The method may furthermore include generating a first contextual value based on the received query. The method may in addition include generating a second contextual value based on the received response. The method may moreover include generating a verification score based on the first contextual value and the second contextual value. The method may also include initiating a mitigation action in response to detecting that the verification score is below a predetermined threshold. Other embodiments of this aspect include corresponding computer systems, apparatus, and computer programs recorded on one or more computer storage devices, each configured to perform the actions of the methods.

Implementations may include one or more of the following features. The method may include: generating the first contextual value based on a first data extracted from a knowledgebase, where the generative AI software application is configured to generate the response based on data of the knowledgebase. The method may include: generating the second contextual value based on a second data extracted from the knowledgebase. The method may include: generating in a vector database a first vector corresponding to the first contextual value; generating in the vector database a second vector corresponding to the second contextual value; determining a distance between the first vector and the second vector; and generating the verification score based on the determined distance. The method may include: accessing a data source, the data source including a plurality of textual data; generating a plurality of textual paragraphs based on the plurality of textual data; generating a paragraph vector for each of the plurality of textual paragraphs; and detecting a textual paragraph of the plurality of textual paragraphs utilized by the generative AI software application to generate the received response based on a vector distance between the textual paragraph and the second vector. The method may include: generating the second contextual value further based on the detected textual paragraph. The method may include: determining a plurality of first distances, each first distance between the first vector and a paragraph vector of a plurality of paragraph vectors; determining a plurality of second distances, each second distance between the second vector and a paragraph vector of the plurality of paragraph vectors; and detecting the textual paragraph based on a first distance of the plurality of first distances which is the shortest and a second distance of the plurality of second distances which is shortest. The method may include: detecting the textual paragraph by providing a prompt to a language model including the received query and the received response. The method may include: accessing a plurality of data sources, each data source including textual data; generating for each textual data a plurality of textual paragraphs; and generating for each text paragraph of the plurality of text paragraphs a plurality of sentences. The method may include: generating each text paragraph of the plurality of paragraphs based on metadata associated with the textual data. The method may include: storing the second vector and the first vector in the vector database; receiving a third vector corresponding to a second query and fourth vector corresponding to a response of the second query; determining a distance between the fourth vector and the second vector; and providing the response associated with the second vector in response to determining that a distance between the third vector and the fourth vector is below a threshold value. Implementations of the described techniques may include hardware, a method or process, or a computer tangible medium.

In one general aspect, non-transitory computer-readable medium may include one or more instructions that, when executed by one or more processors of a device, cause the device to: receive a query directed to a generative AI software application; receive a response to the query, the response generated by the generative AI software application; generate a first contextual value based on the received query; generate a second contextual value based on the received response; generate a verification score based on the first contextual value and the second contextual value; and initiate a mitigation action in response to detecting that the verification score is below a predetermined threshold. Other embodiments of this aspect include corresponding computer systems, apparatus, and computer programs recorded on one or more computer storage devices, each configured to perform the actions of the methods.

In one general aspect, a system may include a processing circuitry. The system may also include a memory, the memory containing instructions that, when executed by the processing circuitry, configure the system to: the system may furthermore include receive a query directed to a generative AI software application. The system may in addition receive a response to the query, the response generated by the generative AI software application. The system may moreover generate a first contextual value based on the received query. The system may also generate a second contextual value based on the received response. The system may furthermore generate a verification score based on the first contextual value and the second contextual value. The system may in addition initiate a mitigation action in response to detecting that the verification score is below a predetermined threshold. Other embodiments of this aspect include corresponding computer systems, apparatus, and computer programs recorded on one or more computer storage devices, each configured to perform the actions of the methods.

Implementations may include one or more of the following features. The system where the memory contains further instructions which when executed by the processing circuitry further configure the system to: generate the first contextual value based on a first data extracted from a knowledgebase, where the generative AI software application is configured to generate the response based on data of the knowledgebase. The system where the memory contains further instructions which when executed by the processing circuitry further configure the system to: generate the second contextual value based on a second data extracted from the knowledgebase. The system where the memory contains further instructions which when executed by the processing circuitry further configure the system to: generate in a vector database a first vector corresponding to the first contextual value; generate in the vector database a second vector corresponding to the second contextual value; determine a distance between the first vector and the second vector; and generate the verification score based on the determined distance. The system where the memory contains further instructions which when executed by the processing circuitry further configure the system to: access a data source, the data source including a plurality of textual data; generate a plurality of textual paragraphs based on the plurality of textual data; generate a paragraph vector for each of the plurality of textual paragraphs; and detect a textual paragraph of the plurality of textual paragraphs utilized by the generative AI software application to generate the received response based on a vector distance between the textual paragraph and the second vector. The system where the memory contains further instructions which when executed by the processing circuitry further configure the system to: generate the second contextual value further based on the detected textual paragraph. The system where the memory contains further instructions which when executed by the processing circuitry further configure the system to: determine a plurality of first distances, each first distance between the first vector and a paragraph vector of a plurality of paragraph vectors; determine a plurality of second distances, each second distance between the second vector and a paragraph vector of the plurality of paragraph vectors; and detect the textual paragraph based on a first distance of the plurality of first distances which is the shortest and a second distance of the plurality of second distances which is shortest. The system where the memory contains further instructions which when executed by the processing circuitry further configure the system to: detect the textual paragraph by providing a prompt to a language model including the received query and the received response. The system where the memory contains further instructions which when executed by the processing circuitry further configure the system to: access a plurality of data sources, each data source including textual data; generate for each textual data a plurality of textual paragraphs; and generate for each text paragraph of the plurality of text paragraphs a plurality of sentences. The system where the memory contains further instructions which when executed by the processing circuitry further configure the system to: generate each text paragraph of the plurality of paragraphs based on metadata associated with the textual data. The system where the memory contains further instructions which when executed by the processing circuitry further configure the system to: store the second vector and the first vector in the vector database; receive a third vector corresponding to a second query and fourth vector corresponding to a response of the second query; determine a distance between the fourth vector and the second vector; and provide the response associated with the second vector in response to determining that a distance between the third vector and the fourth vector is below a threshold value. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example flow diagram of a generative artificial intelligence system having a verification system, utilized to describe an embodiment.

FIG. 2 is an example flow diagram of a verification system for scoring quality of answers of a generative AI system, implemented in accordance with an embodiment.

FIG. 3 is an example verification system utilizing a vector database, implemented in accordance with an embodiment.

FIG. 4 is an example flowchart of a method for generating a verification of a generative AI response, implemented in accordance with an embodiment.

FIG. 5 is an example flowchart of a method for vectorizing a textual resource, implemented in accordance with an embodiment.

FIG. 6 is an example flowchart of a method for verification score generation, implemented according to an embodiment.

FIG. 7 is an example flowchart of a method for determining a verification score for a generative artificial intelligence, implemented in accordance with an embodiment.

FIG. 8 is an example flowchart of a method for generating a verification score for a generative AI output, implemented according to an embodiment.

FIG. 9 is an example flowchart of a method for generating a verification score for a generative AI output, implemented in accordance with an embodiment.

FIG. 10 is an example schematic diagram of a verification system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

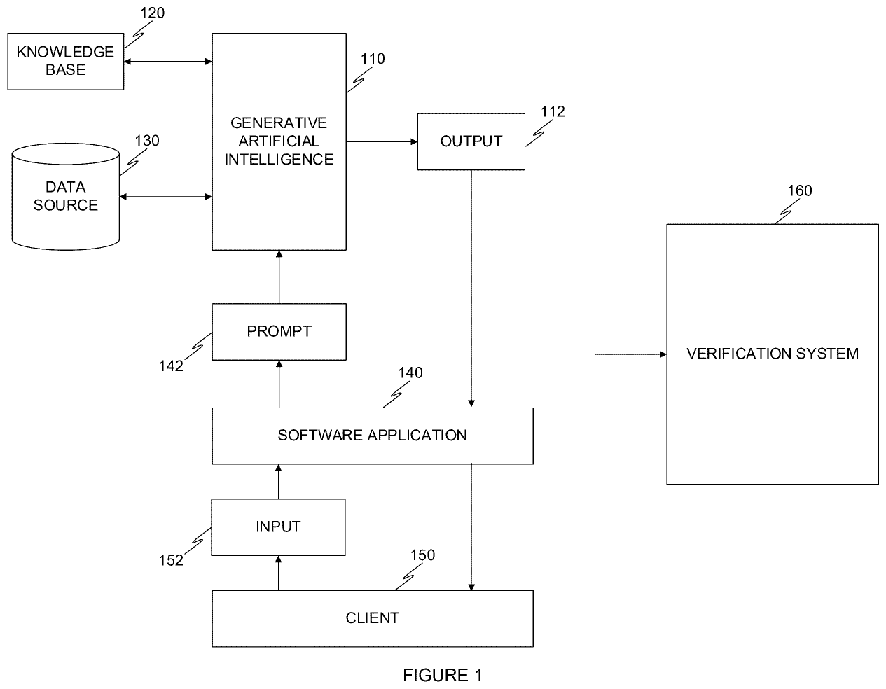

FIG. 1 is an example flow diagram of a generative artificial intelligence system having a verification system, utilized to describe an embodiment. According to an embodiment, a generative artificial intelligence (AI) system 110, is implemented in a computing environment, such as a cloud computing environment.

In some embodiments, the generative AI system 110 includes a unimodal system, a multimodal system, a combination thereof, and the like. In certain embodiments, the generative AI system 110 includes a language model, such as a large language model (LLM). In an embodiment, an LLM is GPT, LaMDA, LLaMa, BERT, and the like.

In an embodiment, the generative AI system 110 is implemented on a virtualized computing environment, such as a virtual machine, a software container platform, a serverless function, a combination thereof, and the like. In some embodiments, the virtualized computing environment is deployed on a physical resource including, for example, an AI accelerator processing circuitry. In an embodiment, such a processing circuitry is implemented as a GPU, a GPGPU, a TPU, an FPGA, an ASIC, a combination thereof, and the like.

In certain embodiments, the generative AI system 110 is configured to access various data sources of an organization. For example, a chatbot software application is a type of generative AI system which is configured to generate responses to natural language queries based on at least a data source of an organization.

According to an embodiment, the generative AI system 110 is configured to access a knowledgebase 120 and a data source 130. In an embodiment, a knowledgebase 120 includes unstructured data, structured data, a combination thereof, and the like. For example, in an embodiment, a knowledgebase 120 is implemented as a Confluence® page, a Slack® channel, and the like.

In some embodiments, a data source 130 includes a database, a ticket issue system, a structured data source, and the like. For example, in an embodiment, a data source 130 includes a data schema, which specifies how data in the data source 130 is stored, accessed, etc.

In an embodiment, the generative AI system 110 is configured to generate an output based on data extracted, accessed, etc., from the knowledgebase 120, the data source 130, a combination thereof, and the like.

According to an embodiment, the generative AI system 110 is configured to receive a prompt 142 which when processed by the generative AI system 110 causes the generative AI system 110 to generate an output 112. In some embodiments, the prompt 142 is an input for the generative AI system 110.

In certain embodiments, a client device 150 is configured to generate an input 152. For example, in an embodiment, the client device 150 is configured to generate an input 152 for a software application 140. In some embodiments, the software application 140 includes a user interface, such as a text interface, a graphical user interface, a combination thereof, and the like.

In an embodiment, the input 152 is a natural language input. For example, the input 152 is a question in a human-readable language, such as English. In an embodiment, the input 152 includes a plurality of characters arranged as words, a plurality of words arranged as a sentence, a plurality of sentences arranged as a paragraph, various combinations thereof, and the like.

In some embodiments, the software application 140 is configured to receive an output 112 of the generative AI system 110. In certain embodiments, the software application 140 is configured to provide the output 112 to the client device 150, for example through the graphical user interface.

In an embodiment, a verification system 160 is configured to receive the input 152, the output 112, a representation thereof, various combinations thereof, and the like. For example, in an embodiment, the verification system 160 is configured to receive a vectorized representation of the input 152, a vectorized representation of the output 112, etc.

According to an embodiment, the verification system 160 is configured to access data sources, such as the knowledgebase 120 and data source 130. In an embodiment, the verification system 160 is further configured to generate a verification score of the output 112 based at least on the input 152. Generation of a verification score is discussed in more detail herein.

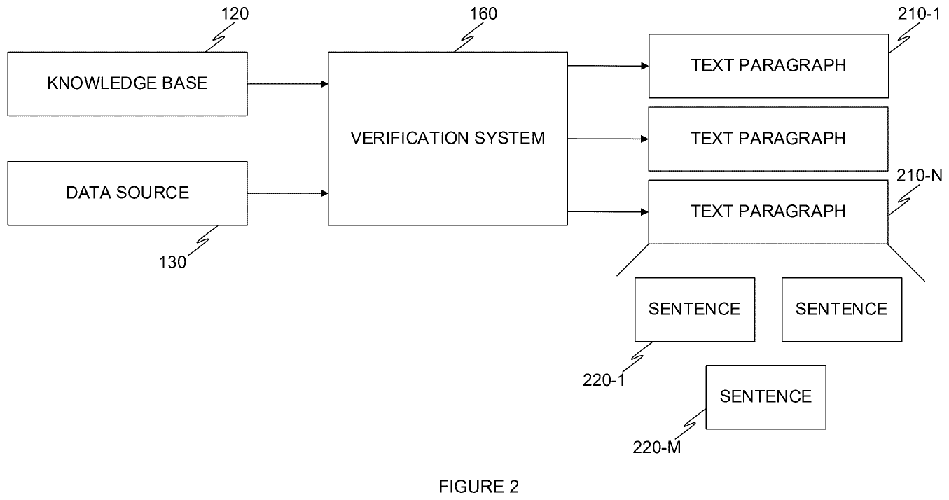

FIG. 2 is an example flow diagram of a verification system for scoring quality of answers of a generative AI system, implemented in accordance with an embodiment. In an embodiment, a verification system 160 is configured to access data sources, such as a knowledgebase 120 and a data source 130. According to an embodiment, a generative AI system is configured to generate an output based on data stored in the data sources.

In an embodiment, the verification system 160 is configured to detect textual data stored in the data sources, and generate therefrom a plurality of text paragraphs 210-1 through 210-N, where ‘N’ is an integer having a value of ‘2’ or greater, referred to generally as text paragraphs 210 and individually as text paragraph 210.

In some embodiments, the verification system 160 is configured to generate text paragraphs 210 based on textual data extracted from a data source, a plurality of data sources, etc. In an embodiment, a text paragraph 210 includes a plurality of sentences. In certain embodiments, a sentence is unique to a text paragraph. According to an embodiment, a sentence includes a plurality of words.

For example, sentence 210-N includes a plurality of sentences 220-1 through 220-M, referenced individually as sentence 220 and collectively as sentences 220, where ‘M’ is an integer having a value of ‘1’ or greater.

In an embodiment, the verification system is configured to generate the plurality of paragraphs, for example, by detecting a plurality of sentences in a textual resource, generating a semantic score for each sentence, and grouping sentences into paragraphs based on the semantic score.

For example, in an embodiment, a semantic score is determined between a first sentence and a next sentence. In response to determining that the score is above a threshold, the first sentence and the next sentence (i.e., the second sentence) are grouped into a single text paragraph 210. In some embodiments, a semantic score is then generated between the second sentence and a next sentence (i.e., a third sentence), between the text paragraph 210 and the third sentence, a combination thereof, and the like. If the semantic score is above a threshold, the third sentence is added to the paragraph 210. Where the semantic score is below a threshold, a new paragraph is generated which includes the third sentence.

According to an embodiment, various methods are utilized in generating paragraphs, including utilizing textual hints (e.g., detecting a carriage, a paragraph mark, a format symbol, etc.). In some embodiments, generating paragraphs is performed based on a clustering technique.

In an embodiment, the verification system 160 is further configured to generate a vectorization of a sentence 220, of a text paragraph 210, of a combination thereof, and the like. In an embodiment, it is advantageous to generate sentences 220 and paragraphs 210 as this allows to generate a verification score expeditiously, as detailed herein.

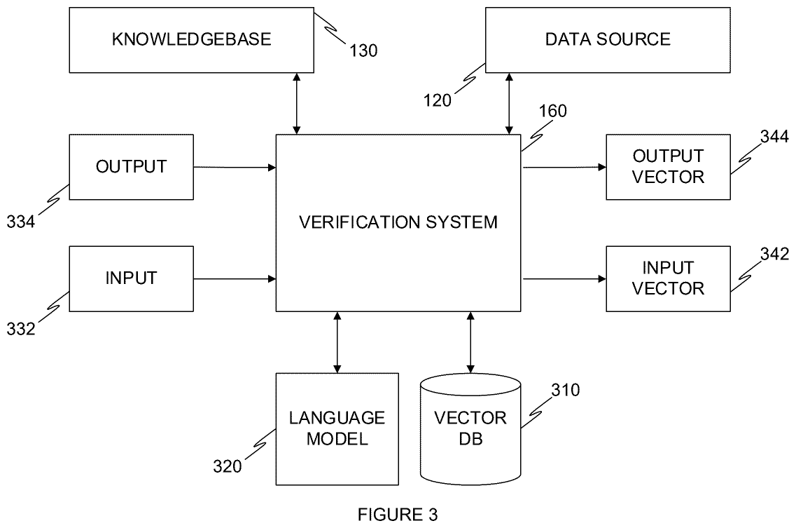

FIG. 3 is an example verification system utilizing a vector database, implemented in accordance with an embodiment. In an embodiment, the verification system 160 is configured to access a data source, such as knowledgebase 120, data source 130, a combination thereof, and the like.

In certain embodiments, the verification system 160 is configured to receive an input 332 and an output 334. In some embodiments, the output 334 is generated based on the input 332.

For example, in an embodiment, the output 334 is generated by a generative AI, such as the generative AI system 110 of FIG. 1. In some embodiments, the verification system 160 is configured to generate a corresponding vector for each received input, such as input 332 and output 334. In certain embodiments, the verification system 160 is configured to generate an output vector 344 based on output 334. In an embodiment, the verification system 160 is configured to generate an input vector 342 based on the input 332.

In an embodiment, the output vector 344, input vector 342, and the like, are generated based on a predefined feature space. In some embodiments, the verification system 160 is configured to perform vector embedding. In certain embodiments, the verification system 160 is further configured to store generated vectors in a vector database 310.

In some embodiments, a language model 320 is utilized to generate the vectors. In some embodiments, the language model 320 is a large language model, a small language model, etc. In an embodiment, the language model 320 is implemented as a generative transformer, such as GPT, BERT, LLaMa, etc.

According to an embodiment, the language model 320 is provided with a prompt, for example, generated based on a predetermined template, which when processed by the language model 320 generates an output vector 344. In some embodiments, the prompt is generated based on the input 332, the output 334, a predetermined prompt template, a combination thereof, and the like.

In certain embodiments, the language model 320 is a language model which is configured to generate an output 334 based on the input 332. In an embodiment, the language model 320 is configured to generate the output 334 for example based on data extracted from the knowledgebase 120, the data source 130, a combination thereof, and the like.

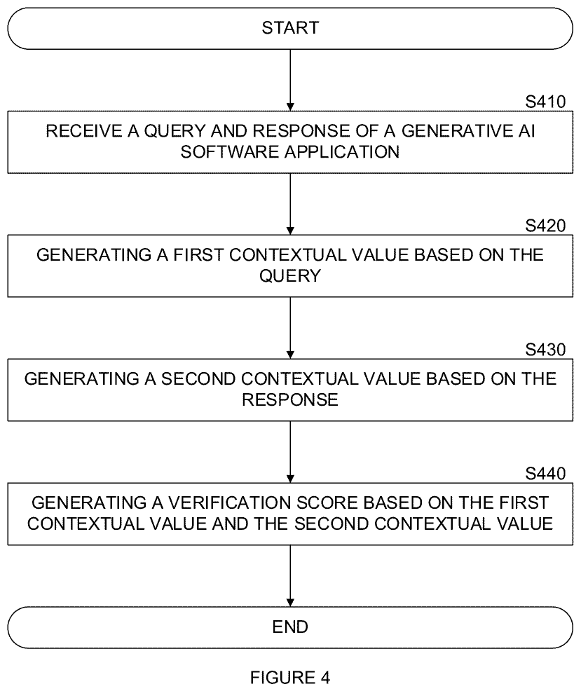

FIG. 4 is an example flowchart of a method for generating a verification of a generative AI response, implemented in accordance with an embodiment.

At S410, a query pair is received. In some embodiments, receiving a query pair includes accessing an application programming interface (API), a data store, a database, etc., through which, or in which, a query pair is stored.

In an embodiment, a query pair includes a query and a response. In some embodiments, the query is a natural language query, a structured query, an unstructured query, a combination thereof, and the like.

In certain embodiments, the response is a response generated based on the query. For example, in an embodiment, the response is generated by a generative AI configured to generate responses to queries based on a data source, a knowledgebase, a combination thereof, and the like. In an embodiment, the response is generated based on structured data, on unstructured data, a combination thereof, and the like.

In an embodiment, the query pair includes a plurality of responses. For example, in some embodiments, each response is generated by a language model based on a different prompt. In certain embodiments, each response is generated by different language models having different context lengths, based on the same query.

At S420, a first contextual value is generated based on the query. In an embodiment, the contextual value is a vector, an embedding value, a score, a combination thereof, and the like. In some embodiments, the first contextual value is generated by computing a projection based on the query into a space, such as a feature space. For example, in an embodiment, the projection is a vector embedding, such that a vector representing the query is generated in a feature space. In an embodiment, the first contextual value is a representation, a plurality of representations, and the like, of the query.

At S430, a second contextual value is generated based on the response. In an embodiment, the contextual value is a vector, an embedding value, a score, a combination thereof, and the like. In some embodiments, the second contextual value is generated by computing a projection based on the response into a space, such as a feature space. For example, in an embodiment, the projection is a vector embedding, such that a vector representing the response is generated in a feature space. In an embodiment, the second contextual value is a representation, a plurality of representations, and the like, of the response.

At S440, a verification score is generated. In an embodiment, the verification score is generated based on the first contextual value, the second contextual value, a combination thereof, and the like.

In some embodiments, the verification score represents a distance between the first contextual value and the second contextual value. For example, in certain embodiments, where the contextual values are vectors in a feature space, a distance between the first contextual value (i.e., a first vector in the feature space) and the second contextual value (i.e., a second vector in the feature space) indicate how similar the first contextual value and the second contextual value are to each other.

In an embodiment, the verification score, the first contextual value, the second contextual value, etc., are each generated by a language model, for example based on a predetermined prompt which is adapted based on the query, the response, the first contextual value, the second contextual value, a combination thereof, and the like.

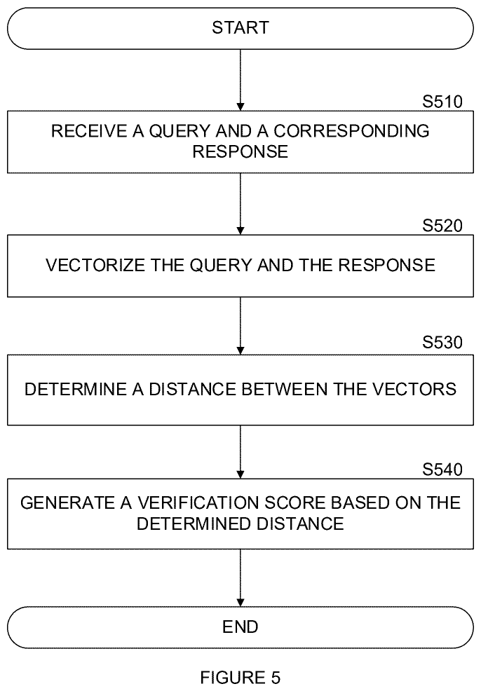

FIG. 5 is an example flowchart of a method for vectorizing a textual resource, implemented in accordance with an embodiment.

At S510, a query pair is received. In some embodiments, receiving a query pair includes accessing an application programming interface (API), a data store, a database, etc., through which, or in which, a query pair is stored.

In an embodiment, a query pair includes a query and a response. In some embodiments, the query is a natural language query, a structured query, an unstructured query, a combination thereof, and the like.

In certain embodiments, the response is a response generated based on the query. For example, in an embodiment, the response is generated by a generative AI configured to generate responses to queries based on a data source, a knowledgebase, a combination thereof, and the like. In an embodiment, the response is generated based on structured data, on unstructured data, a combination thereof, and the like.

In an embodiment, the query pair includes a plurality of responses. For example, in some embodiments, each response is generated by a language model based on a different prompt. In certain embodiments, each response is generated by different language models having different context lengths, based on the same query.

At S520, vectorization is initiated. In an embodiment, a query, a response, etc., are each vectorized. In some embodiments, vectorization includes generating a vector in a vector database based on a feature space and the query, the response, etc.

In some embodiments, the query, response, etc., are preprocessed prior to initiating vectorization. For example, according to an embodiment, certain predetermined words are removed from the query, such as grammatical articles (i.e., “the”, “a”, “an”, etc.). In an embodiment, this is advantageous as certain words contain less contextual information than others, and therefore there is little to no advantage in processing these words for generating a vector.

In an embodiment, vectorization is performed utilizing techniques such as word2vec, doc2vec, top2vec, a combination thereof, and the like. In some embodiments, a plurality of vectors are generated, for example based on different techniques, for each of the query and the response. For example, in an embodiment, a first vector is generated based on the query utilizing word2vec, a second vector is generated based on the query utilizing doc2vec, etc.

At 530, a vector distance is determined. In an embodiment, the distance is based on a first vector (e.g., which is generated based on the query) and a second vector (e.g., which is generated based on the response).

In an embodiment, the vector distance is generated based on a cosine similarity between the first vector and the second vector. According to some embodiments, a cosine similarity is a measure of similarity between two vectors which is based on an inner product space. In other embodiments, various techniques are utilized in determining a similarity between the first vector and the second vector.

At S540, a verification score is generated. In an embodiment, the verification score is generated based on the determined distance. In some embodiments, the verification score is generated based on a similarity metric which is generated between the query and a first response, the query and a second response, a combination thereof, and the like.

In some embodiments, the verification score is generated such that the score is normalized between a range of numerical values, e.g., between 0 and 100, between 0 and 1, etc.

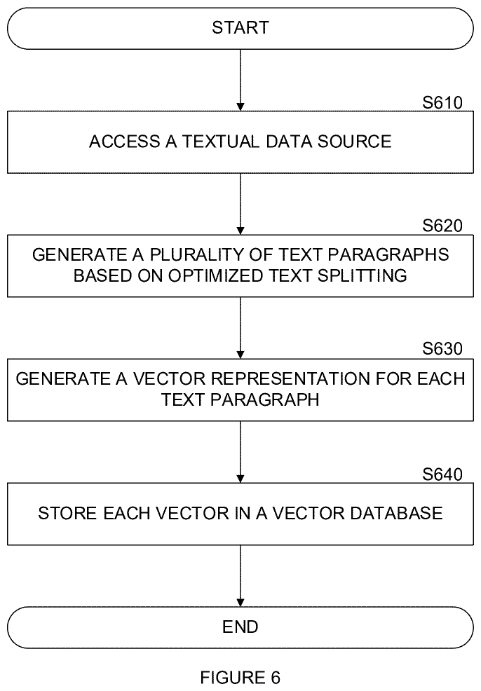

FIG. 6 is an example flowchart of a method for verification score generation, implemented according to an embodiment. In an embodiment, the method disclosed in FIG. 6 is utilized as a component of verification score generation, such as described in more detail herein.

At S610, a data source is accessed. In an embodiment, the data source includes structured data, unstructured data, a combination thereof, and the like. For example, in an embodiment, the data source is a knowledgebase, including textual articles. In some embodiments, the data source is multimodal, such that it includes textual data, graphical data, visual data, etc.

In an embodiment, accessing a data source includes receiving a token, an authorization, a credential, and the like, which is utilized to access the data source. In some embodiments, a portion of the data source is accessible, and another portion of the data source is inaccessible.

In certain embodiments, a data source including text (also referred to as a textual data source) includes a document, which is formatted as pages, paragraphs, and arranges words as sentences.

At S620, a plurality of paragraphs are generated. In an embodiment, a textual data source is processed to detect a plurality of sentences. In some embodiments, the plurality of paragraphs are generated based on the detected plurality of sentences.

In an embodiment, a paragraph is generated based on a plurality of sentences in sequential order, such that each sentence, other than the first sentence, is semantically related to a previous sentence. In some embodiments, the first sentence is not semantically related to a last sentence of the previous paragraph.

According to some embodiments, a sentence is semantically related to another sentence when a semantic score, indicates that the sentences are semantically related. In an embodiment, the semantic score is generated based on a cosine similarity between a representation of a first sentence and a representation of a second sentence. In an embodiment, the semantic score is generated based on a cosine similarity between a representation of a first sentence and a representation of a plurality of second sentences.

At S630, a representation is generated for each paragraph. In an embodiment, a vector representation is generated for each paragraph. In some embodiments, the paragraph is processed to generate a temporary paragraph which includes only words which are contextually significant. For example, a grammatical article is insignificant contextually, in an embodiment.

According to certain embodiments, the representation is generated as a vector in a vector space. In some embodiments, a query, a response, and the like, are mapped into the vector space.

At S640, a representation is stored. In an embodiment, the representation is a vector representation which is stored in a vector database. According to an embodiment, the representations of the paragraph are stored prior to initiation of a verification process.

In an embodiment, generating the paragraphs based on semantic scores, prior to initiating a verification process, allows to decrease the time required to compute a verification score.

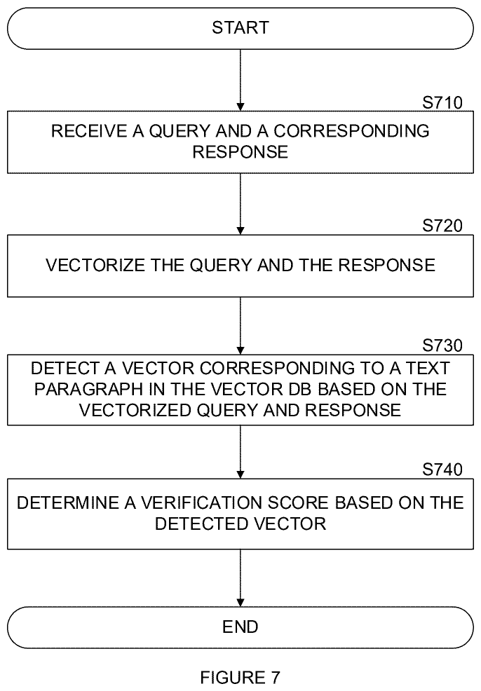

FIG. 7 is an example flowchart of a method for determining a verification score for a generative artificial intelligence, implemented in accordance with an embodiment.

At S710, a query pair is received. In some embodiments, receiving a query pair includes accessing an application programming interface (API), a data store, a database, etc., through which, or in which, a query pair is stored.

In an embodiment, a query pair includes a query and a response. In some embodiments, the query is a natural language query, a structured query, an unstructured query, a combination thereof, and the like.

In certain embodiments, the response is a response generated based on the query. For example, in an embodiment, the response is generated by a generative AI configured to generate responses to queries based on a data source, a knowledgebase, a combination thereof, and the like. In an embodiment, the response is generated based on structured data, on unstructured data, a combination thereof, and the like.

In an embodiment, the query pair includes a plurality of responses. For example, in some embodiments, each response is generated by a language model based on a different prompt. In certain embodiments, each response is generated by different language models having different context lengths, based on the same query.

At S720, vectorization is initiated. In an embodiment, a query, a response, etc., are each vectorized. In some embodiments, vectorization includes generating a vector in a vector database based on a feature space and the query, the response, etc.

In some embodiments, the query, response, etc., are preprocessed prior to initiating vectorization. For example, according to an embodiment, certain predetermined words are removed from the query, such as grammatical articles (i.e., “the”, “a”, “an”, etc.). In an embodiment, this is advantageous as certain words contain less contextual information than others, and therefore there is little to no advantage in processing these words for generating a vector.

In an embodiment, vectorization is performed utilizing techniques such as word2vec, doc2vec, top2vec, a combination thereof, and the like. In some embodiments, a plurality of vectors are generated, for example based on different techniques, for each of the query and the response. For example, in an embodiment, a first vector is generated based on the query utilizing word2vec, a second vector is generated based on the query utilizing doc2vec, etc.

At S730, a paragraph is detected. In an embodiment, detecting a paragraph includes detecting a representation of the paragraph. In some embodiments, the representation of the paragraph is a vector representation. In an embodiment, the vector representations of the query, the response, the paragraph, etc., are all vectors in a same feature space.

According to some embodiments, detecting a paragraph is performed based on a semantic similarity between the paragraph and the query, between the paragraph and the response, between the paragraph and the query and the response, etc.

In an embodiment, a semantic similarity is determined based on a cosine similarity. In some embodiments, the cosine similarity is generated based on a vector representing the paragraph, a vector representing the query, a vector representing the response, a combination thereof, and the like.

In certain embodiments, a plurality of paragraphs are detected based on a similarity score generated for each paragraph. In some embodiments, the similarity score where the similarity score exceeds a threshold a paragraph is considered to be semantically similar to the query, similar to the response, etc.

At S740, a verification score is generated. In an embodiment, the verification score is generated based on the similarity score. In some embodiments, the verification score is generated based on a similarity score between the paragraph and the response, a similarity score between the paragraph and the query, a combination thereof, and the like.

According to an embodiment, a first verification score is generated between a first detected paragraph and a query, and a second verification score is generated between a second detected paragraph and a response.

In an embodiment, where the first verification score and the second verification score are within a threshold value of each other, a final verification score is generated based on the first verification score and the second verification score. In certain embodiments, where the first verification score and the second verification score are not within a threshold value of each other, the final verification score indicates that there is a mismatch.

In some embodiments, the verification score is generated based on a similarity score, where the similarity score is a numerical value. In certain embodiments, the verification score is a numerical value, an alphanumerical value, a quantitative value, a qualitative value, a combination thereof, and the like.

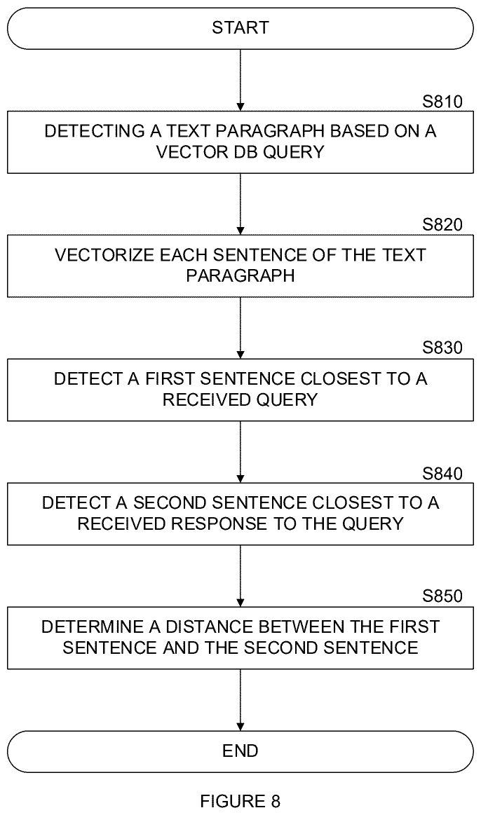

FIG. 8 is an example flowchart of a method for generating a verification score for a generative AI output, implemented according to an embodiment. According to an embodiment, it is advantageous to detect a source from which the generative AI generated an output (i.e., a response to a query).

Generative AI systems do not provide a source for a generated response, in some embodiments. This is sometimes further exacerbated, in certain embodiments, due to generative AI systems generating different outputs when provided with the same input.

It is therefore advantageous to be able to trace a lineage of an output to a data source which is utilized by the generative AI for generating the output, to determine, for example, if the output is generated based on data from a data source, or if the output is a result of what is termed in the art a “hallucination”.

At S810, a textual paragraph is detected. In an embodiment, a first text paragraph is detected for a received query, and a second text paragraph is detected for a received response.

According to an embodiment, detecting a text paragraph includes generating a vector representation of a query, generating a vector representation of a response, etc., and detecting in a vector database a vector stored therein which represents a text paragraph. In an embodiment, a vector representing a text paragraph is detected when a cosine similarity (or other distance measure) is below a predetermined threshold.

In some embodiments, for example where no text paragraph is represented by a vector having a distance below the predetermined threshold, a closest vector is select, i.e., the vector having the shortest distance to a vector of the query, vector of the response, etc.

In certain embodiments, a plurality of text paragraphs are detected. In some embodiments, a text paragraph is selected based on a combined distance from the query vector and from the response vector (i.e., the sum of the distances is smallest).

At S820, each sentence of the paragraph is vectorized. In an embodiment, vectorizing a paragraph prior to initiating a verification process for an output of a generative AI allows to then establish, in real-time (or near real-time) a closest sentence by only vectorizing in real-time the sentences from the most related paragraph. An additional advantage, in some embodiments, is reducing the amount of stored vectors in the vector database. In other words, rather than initially vectorizing each sentence of each data source, only paragraphs are vectorized.

The appropriately selected paragraph is then processed to vectorize only the sentences of the selected paragraph, thereby providing for a speedier and more computationally efficient process. In an embodiment, vectorizing each sentence includes generating a vector for each sentence in a feature space in which the textual paragraphs are embedded.

At S830, a first sentence is detected. In an embodiment, the first sentence is selected from the detected paragraph. According to certain embodiments, the first sentence is detected by selecting a sentence of a plurality of sentences of the paragraph, represented by a sentence vector having a distance to a vector representing the query which is below a threshold.

In an embodiment, a plurality of sentences are represented by corresponding vectors, each of which has a distance shorter than the threshold value to the vector representing the query. In such embodiments, for example, a verification system is configured to select a sentence represented by a vector which has the shortest distance to the vector representing the query.

At S840, a second sentence is detected. In an embodiment, the second sentence is selected from the detected paragraph. According to certain embodiments, the second sentence is detected by selecting a sentence of a plurality of sentences of the paragraph, represented by a sentence vector having a distance to a vector representing the response which is below a threshold.

In an embodiment, a plurality of sentences are represented by corresponding vectors, each of which has a distance shorter than the threshold value to the vector representing the response. In such embodiments, for example, a verification system is configured to select a sentence represented by a vector which has the shortest distance to the vector representing the response.

At S850, a similarity is determined between the first sentence and the second sentence. In an embodiment, the similarity is determined based on a distance between a vector representing the first sentence and a vector representing the second sentence.

According to an embodiment, where the distance is below a threshold value, a verification score is generated which indicates that the response is verified. In some embodiments, where the distance is above the threshold value, a verification score is generated which indicates that the response is unverified.

In certain embodiments, where the distance exceeds a second threshold value, higher than the previous threshold value, a verification score is generated which indicates that the response is a false response.

In an embodiment, where the response is indicated to be a false response, the verification system is configured to initiate generation of a new response. For example, according to some embodiments, the verification system is configured to initiate a language model (e.g., an LLM) to generate an output, for example based on a prompt. In some embodiments, the prompt is generated based on the query, and a textual paragraph represented by a vector having a semantic similarity to the query.

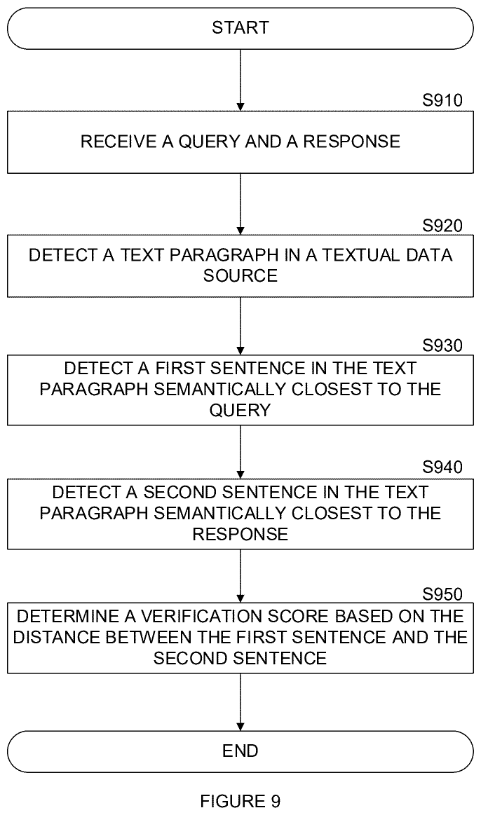

FIG. 9 is an example flowchart of a method for generating a verification score for a generative AI output, implemented in accordance with an embodiment.

At S910, a query pair is received. In some embodiments, receiving a query pair includes accessing an application programming interface (API), a data store, a database, etc., through which, or in which, a query pair is stored.

In an embodiment, a query pair includes a query and a response. In some embodiments, the query is a natural language query, a structured query, an unstructured query, a combination thereof, and the like.

In certain embodiments, the response is a response generated based on the query. For example, in an embodiment, the response is generated by a generative AI configured to generate responses to queries based on a data source, a knowledgebase, a combination thereof, and the like. In an embodiment, the response is generated based on structured data, on unstructured data, a combination thereof, and the like.

In an embodiment, the query pair includes a plurality of responses. For example, in some embodiments, each response is generated by a language model based on a different prompt. In certain embodiments, each response is generated by different language models having different context lengths, based on the same query.

In an embodiment, a query, a response, etc., are each vectorized. In some embodiments, vectorization includes generating a vector in a vector database based on a feature space and the query, the response, etc.

In some embodiments, the query, response, etc., are preprocessed prior to initiating vectorization. For example, according to an embodiment, certain predetermined words are removed from the query, such as grammatical articles (i.e., “the”, “a”, “an”, etc.). In an embodiment, this is advantageous as certain words contain less contextual information than others, and therefore there is little to no advantage in processing these words for generating a vector.

In an embodiment, vectorization is performed utilizing techniques such as word2vec, doc2vec, top2vec, a combination thereof, and the like. In some embodiments, a plurality of vectors are generated, for example based on different techniques, for each of the query and the response. For example, in an embodiment, a first vector is generated based on the query utilizing word2vec, a second vector is generated based on the query utilizing doc2vec, etc.

At S920, a textual paragraph is detected. In an embodiment, a first text paragraph is detected for a received query, and a second text paragraph is detected for a received response.

According to an embodiment, detecting a text paragraph includes generating a vector representation of a query, generating a vector representation of a response, etc., and detecting in a vector database a vector stored therein which represents a text paragraph. In an embodiment, a vector representing a text paragraph is detected when a cosine similarity (or other distance measure) is below a predetermined threshold.

In some embodiments, for example where no text paragraph is represented by a vector having a distance below the predetermined threshold, a closest vector is select, i.e., the vector having the shortest distance to a vector of the query, vector of the response, etc.

In certain embodiments, a plurality of text paragraphs are detected. In some embodiments, a text paragraph is selected based on a combined distance from the query vector and from the response vector (i.e., the sum of the distances is smallest).

At S930, a first sentence is detected. In an embodiment, the first sentence is selected from the detected paragraph. In some embodiments, the first sentence is a sentence which is semantically closest to the query. According to certain embodiments, the first sentence is detected by selecting a sentence of a plurality of sentences of the paragraph, represented by a sentence vector having a distance to a vector representing the query which is below a threshold.

In an embodiment, a plurality of sentences are represented by corresponding vectors, each of which has a distance shorter than the threshold value to the vector representing the query. In such embodiments, for example, a verification system is configured to select a sentence represented by a vector which has the shortest distance to the vector representing the query.

At S940, a second sentence is detected. In an embodiment, the second sentence is selected from the detected paragraph. In some embodiments, the second sentence is semantically closest to the response. In an embodiment, the first sentence and the second sentence are the same sentence. According to certain embodiments, the second sentence is detected by selecting a sentence of a plurality of sentences of the paragraph, represented by a sentence vector having a distance to a vector representing the response which is below a threshold.

In an embodiment, a plurality of sentences are represented by corresponding vectors, each of which has a distance shorter than the threshold value to the vector representing the response. In such embodiments, for example, a verification system is configured to select a sentence represented by a vector which has the shortest distance to the vector representing the response.

At S950, a verification score is generated. In an embodiment, the verification score is generated based on a value related to the semantic similarity between the first sentence and the second sentence. In some embodiments, the verification score is generated based on a value related to the semantic similarity between the query and the first sentence, based on a value related to the semantic similarity between the response and the second sentence, based on a combination thereof, and the like.

In some embodiments, the verification score includes a numerical value, an alphanumerical value, a quantitative value, a qualitative value, a combination thereof, and the like. In certain embodiments, where the verification score is below a predetermined threshold value, a mitigation action is initiated.

According to certain embodiments, a mitigation action includes generating a new response, generating a notification that the response is unverified, generating a notification indicating that the response is false, a combination thereof, and the like.

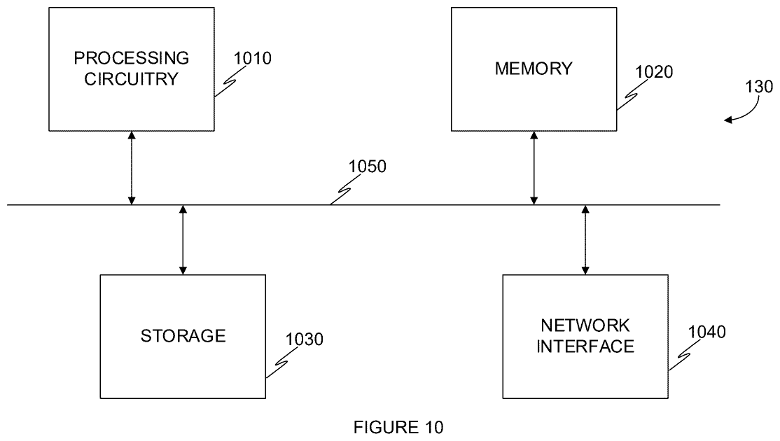

FIG. 10 is an example schematic diagram of a verification system 160 according to an embodiment. The verification system 160 includes, according to an embodiment, a processing circuitry 1010 coupled to a memory 1020, a storage 1030, and a network interface 1040. In an embodiment, the components of the verification system 160 are communicatively connected via a bus 1050.

In certain embodiments, the processing circuitry 1010 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information.

In an embodiment, the memory 1020 is a volatile memory (e.g., random access memory, etc.), a non-volatile memory (e.g., read only memory, flash memory, etc.), a combination thereof, and the like. In some embodiments, the memory 1020 is an on-chip memory, an off-chip memory, a combination thereof, and the like. In certain embodiments, the memory 1020 is a scratch-pad memory for the processing circuitry 1010.

In one configuration, software for implementing one or more embodiments disclosed herein is stored in the storage 1030, in the memory 1020, in a combination thereof, and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 1010, cause the processing circuitry 1010 to perform the various processes described herein, in accordance with an embodiment.

In some embodiments, the storage 1030 is a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 1040 is configured to provide the verification system 160 with communication with, for example, the generative artificial intelligence 110, data source 130, knowledgebase 120, and the like, according to an embodiment.

It should be understood that the embodiments described herein are not limited to the specific architecture illustrated in FIG. 10, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

1. A method for improving generative artificial intelligence (AI) software application response, comprising:
receiving a query directed to a generative AI software application;
receiving a response to the query, the response generated by the generative AI software application;
generating a first contextual value based on the received query;
generating a second contextual value based on the received response;
generating a verification score, based on a value related to a semantic similarity between the received query and the received response, based on the first contextual value and the second contextual value; and
initiating a mitigation action in response to detecting that the verification score is below a predetermined threshold.

2. The method of claim 1, further comprising:
generating the first contextual value based on a first data extracted from a knowledgebase, wherein the generative AI software application is configured to generate the response based on data of the knowledgebase.

3. The method of claim 2, further comprising:
generating the second contextual value based on a second data extracted from the knowledgebase.

4. The method of claim 1, further comprising:
generating in a vector database a first vector corresponding to the first contextual value;
generating in the vector database a second vector corresponding to the second contextual value;
determining a distance between the first vector and the second vector; and
generating the verification score based on the determined distance.

5. The method of claim 4, further comprising:
accessing a data source, the data source including a plurality of textual data;
generating a plurality of textual paragraphs based on the plurality of textual data;
generating a paragraph vector for each of the plurality of textual paragraphs; and
detecting a textual paragraph of the plurality of textual paragraphs utilized by the generative AI software application to generate the received response based on a vector distance between the textual paragraph and the second vector.

6. The method of claim 5, further comprising:
generating the second contextual value further based on the detected textual paragraph.

7. The method of claim 5, further comprising:
determining a plurality of first distances, each first distance between the first vector and a paragraph vector of a plurality of paragraph vectors;
determining a plurality of second distances, each second distance between the second vector and a paragraph vector of the plurality of paragraph vectors; and
detecting the textual paragraph based on a first distance of the plurality of first distances which is the shortest and a second distance of the plurality of second distances which is shortest.

8. The method of claim 5, further comprising:
detecting the textual paragraph by providing a prompt to a language model including the received query and the received response.

9. The method of claim 4, further comprising:
accessing a plurality of data sources, each data source including textual data;
generating for each textual data a plurality of textual paragraphs; and
generating for each text paragraph of the plurality of text paragraphs a plurality of sentences.

10. The method of claim 9, further comprising:
generating each text paragraph of the plurality of paragraphs based on metadata associated with the textual data.

11. The method of claim 4, further comprising:
storing the second vector and the first vector in the vector database;
receiving a third vector corresponding to a second query and fourth vector corresponding to a response of the second query;
determining a distance between the fourth vector and the second vector; and
providing the response associated with the second vector in response to determining that a distance between the third vector and the fourth vector is below a threshold value.

12. A non-transitory computer-readable medium storing a set of instructions for improving generative artificial intelligence (AI) software application response, the set of instructions comprising:
one or more instructions that, when executed by one or more processors of a device, cause the device to:
receive a query directed to a generative AI software application;
receive a response to the query, the response generated by the generative AI software application;
generate a first contextual value based on the received query;
generate a second contextual value based on the received response;
generate a verification score, based on a value related to a semantic similarity between the received query and the received response, based on the first contextual value and the second contextual value; and
initiate a mitigation action in response to detecting that the verification score is below a predetermined threshold.

13. A system for improving generative artificial intelligence (AI) software application response comprising:
a processing circuitry;
a memory, the memory containing instructions that, when executed by the processing circuitry, configure the system to:
receive a query directed to a generative AI software application;
receive a response to the query, the response generated by the generative AI software application;
generate a first contextual value based on the received query;
generate a second contextual value based on the received response;
generate a verification score, based on a value related to a semantic similarity between the received query and the received response, based on the first contextual value and the second contextual value; and
initiate a mitigation action in response to detecting that the verification score is below a predetermined threshold.

14. The system of claim 13, wherein the memory contains further instructions which when executed by the processing circuitry further configure the system to:
generate the first contextual value based on a first data extracted from a knowledgebase, wherein the generative AI software application is configured to generate the response based on data of the knowledgebase.

15. The system of claim 14, wherein the memory contains further instructions which when executed by the processing circuitry further configure the system to:
generate the second contextual value based on a second data extracted from the knowledgebase.

16. The system of claim 13, wherein the memory contains further instructions which when executed by the processing circuitry further configure the system to:
generate in a vector database a first vector corresponding to the first contextual value;
generate in the vector database a second vector corresponding to the second contextual value;
determine a distance between the first vector and the second vector; and
generate the verification score based on the determined distance.

17. The system of claim 16, wherein the memory contains further instructions which when executed by the processing circuitry further configure the system to:
access a data source, the data source including a plurality of textual data;
generate a plurality of textual paragraphs based on the plurality of textual data;
generate a paragraph vector for each of the plurality of textual paragraphs; and
detect a textual paragraph of the plurality of textual paragraphs utilized by the generative AI software application to generate the received response based on a vector distance between the textual paragraph and the second vector.

18. The system of claim 17, wherein the memory contains further instructions which when executed by the processing circuitry further configure the system to:
generate the second contextual value further based on the detected textual paragraph.

19. The system of claim 17, wherein the memory contains further instructions which when executed by the processing circuitry further configure the system to:
determine a plurality of first distances, each first distance between the first vector and a paragraph vector of a plurality of paragraph vectors;
determine a plurality of second distances, each second distance between the second vector and a paragraph vector of the plurality of paragraph vectors; and
detect the textual paragraph based on a first distance of the plurality of first distances which is the shortest and a second distance of the plurality of second distances which is shortest.

20. The system of claim 17, wherein the memory contains further instructions which when executed by the processing circuitry further configure the system to:
detect the textual paragraph by providing a prompt to a language model including the received query and the received response.

21. The system of claim 16, wherein the memory contains further instructions which when executed by the processing circuitry further configure the system to:
access a plurality of data sources, each data source including textual data;
generate for each textual data a plurality of textual paragraphs; and
generate for each text paragraph of the plurality of text paragraphs a plurality of sentences.

22. The system of claim 21, wherein the memory contains further instructions which when executed by the processing circuitry further configure the system to:
generate each text paragraph of the plurality of paragraphs based on metadata associated with the textual data.

23. The system of claim 16, wherein the memory contains further instructions which when executed by the processing circuitry further configure the system to:
store the second vector and the first vector in the vector database;
receive a third vector corresponding to a second query and fourth vector corresponding to a response of the second query;
determine a distance between the fourth vector and the second vector; and
provide the response associated with the second vector in response to determining that a distance between the third vector and the fourth vector is below a threshold value.
